(19) United States
(12) Patent Application Publication
(10) Pub. No.: US 2024/0080386 A1
(43) Pub. Date: Mar. 7, 2024

(54) SYSTEMS AND METHODS FOR SOUND AWARENESS ENHANCEMENT

(71) Applicants: Joseph Anthony Pillitteri, Colorado Springs, CO (US); Ginger Diane Pillitteri, Colorado Springs, CO (US)

(72) Inventors: Joseph Anthony Pillitteri, Colorado Springs, CO (US); Ginger Diane Pillitteri, Colorado Springs, CO (US)

(21) Appl. No.: 17/939,886

(22) Filed: Sep. 7, 2022

(51) Int. Cl. H04M 1/72412; G06F 3/16; H04M 1/03; H04M 1/72454

(52) U.S. Cl. CPC H04M 1/72412; G06F 3/165; G06F 3/167; H04M 1/03; H04M 1/72454; H04M 2201/40

(57) ABSTRACT

Computer-implemented sound awareness enhancement methods, systems, and computer-readable media are described.

### FIELD

Some implementations are generally related to electronic and computerized audio processing, and, more particularly, to system and methods for sound awareness enhancement digital audio processing.

### BACKGROUND

There are many situations in which a person may need to hear a given sound (e.g., a voice of another person) and may not want to hear other sounds (e.g., background noise). For example, some people with special needs may require a relatively quiet environment so as to avoid over stimulation though sound but may need to hear the voice of a teacher or parent. In another example, people using mobile devices and listening to audio from the mobile devices via headphones may wish to have reduced ambient sounds (e.g., noise cancellation) but maintain an ability to hear other sounds (e.g., voices of people nearby, etc.) and that can be configured and operated according to parental (or other user) controls. Conventional noise cancellation systems may not provide a capability of selective enhancing sound awareness by keeping or amplifying certain sounds such as voices, alarms, sirens, etc., while reducing or elimination other sounds background noise, dangerously loud sounds, etc.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a block diagram of an example system and a network environment which may be used for one or more implementations described herein.

FIG. 2 is a diagram of an example sound awareness enhancement system including noise canceling headphones in accordance with some implementations.

FIG. 3 is a diagram of an example sound awareness enhancement system including an audio system in accordance with some implementations.

FIG. 4 is a diagram of an example sound awareness enhancement system including a noise canceling audio system in accordance with some implementations.

FIG. 5 is a diagram of an example sound awareness enhancement system including a hearing protection system in accordance with some implementations.

FIG. 6 is a diagram of an example sound awareness enhancement system including a mobile device in accordance with some implementations.

FIG. 7 is a diagram of an example sound awareness enhancement system including a vehicle audio system with noise canceling features in accordance with some implementations.

FIG. 8 is a diagram of an example sound awareness enhancement system including a vehicle audio system in communication with mobile devices in accordance with some implementations.

FIG. 9 is a diagram of an example sound awareness enhancement system including a public transportation vehicle audio system in accordance with some implementations.

FIG. 10 is a diagram of an example sound awareness enhancement system including an audio system in communication with one or more mobile devices in accordance with some implementations.

FIG. 11 is a diagram of an example sound awareness enhancement system including mobile communication devices with a primary device and one or more secondary devices in accordance with some implementations.

FIG. 12 is a block diagram of an example computing device which may be used for one or more implementations described herein.

### DETAILED DESCRIPTION

Some implementations include sound awareness enhancement methods and systems.

Some implementations can include an application in which normal ambient sounds are permitted to the user's ears, but which provides protection at certain decibels (e.g., as in a military application such that a user can hear normal sounds but protects the user's hearing from explosions or other loud sounds). Some implementations can reduce ambient sounds but permit specific sounds to enter. Further, some implementations can amplify, magnify or enhance specific sounds (e.g., a specific teacher, parent, spouse, coworker, etc.). Some implementations are customizable so that a user can select what they want to hear and at what level. Some implementations can combine known or later developed noise canceling techniques, sound amplification techniques, sound equalization techniques, volume reduction techniques, audio mixing techniques, and/or audio sound (e.g., speech or other sound) detection and recognition techniques, or the like. It will be appreciated that the specific techniques used to achieve the audio features and functions described herein can vary and that a given technique (or set of techniques) can be selected by a person of ordinary skill in the art for a contemplated embodiment. The disclosed subject matter relates to the use of the audio techniques (and in some cases electronic and computer hardware) in a specific combination or sequence to achieve a desired result as set forth in the example implementations discussed herein.

Some implementations can selectively raise, lower, or leave unmodified the levels of specific sounds depending on the need or application and what the user wants or needs to hear. The sounds that are selected for listening could be amplified and sent through earphones, smart speakers, speakers, vehicle audio systems/speakers, etc. The system could also be an app running on multiple user devices (e.g., running in the background) such as mobile devices, game systems, etc., and puts selected sounds over the music, video, game or other audio that is playing. Similar to the way navigation, ring tone, or notification does. For example, if users' devices are all set to amplify or at least not cancel the sound of a given person speaking, when that person talks, the sound of the person's voice is picked up by the vehicle sound system or by a device the person is using, and the person can simply talk in a van (or other vehicle) and the kids or other passengers can hear the person's voice through their earphones while listening to something else. The music or video could be automatically lowered in volume to make audio “room” for the selected voice to come through. Other applications include, but are not limited to, industrial, military, police, fire, etc. For example, in a military or first responder application, a commander gets priority so when he or she speaks the other radio traffic volume goes down and outside noise gets cancelled or left unchanged.

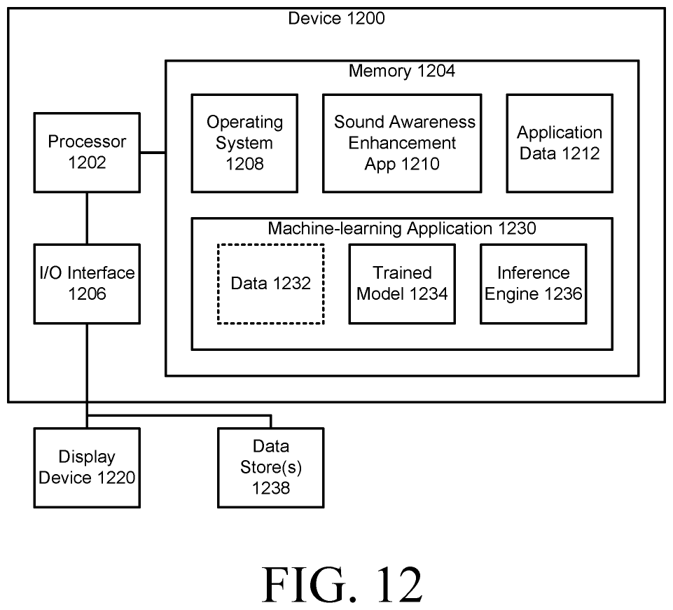

When performing sound awareness enhancement functions, it may be helpful for a system to make predictions about which portions of sound to enhance and which to attenuate or eliminate. To make predictions or suggestions, a probabilistic model (or other model as described below in conjunction with FIG. 12) can be used to make an inference (or prediction) about aspects of sound awareness enhancement such as selected sounds, background noise, etc. Accordingly, it may be helpful to make an inference regarding a probability that a sound is a selected sound or a background sound. Other aspects can be predicted or suggested as described below.

In some implementations, the system acknowledges the individual sound that a user wishes to enhance. This can be done in multiple ways. For example, the system can include a functionality where the system (e.g., running in a mobile device with a microphone) monitors sound for ambient noise and identifies what the individual noises are and then a user can select the sound they wish to hear (e.g., a specific person's voice) so in the moment settings can automatically change based on a user's location and/or type of location (e.g., school vs mall vs church, etc.). The system can remember that location and that voice and the next time the user is in that location, the system can ask the user if the user would like to enhance the same person's voice. Another way to hear that person's voice can be through a tether system. For example, mom's and dad's voices are paired using their headphones or using a device microphone so a user could download the application on one phone or on all phones for a family (e.g., parents and child) and the system tethers them together to understand that mom or dad's voice can supersede ambient sound or sounds being played on a user's device.

Some implementations can include hearing aids personal amplification products that selectively elevate one type of noise over the other. For example, a user (e.g., grandpa) has their hearing aids in and is watching television. The hearing aid can elevate the television sound with this device, which will also specifically listen for the wife's voice. When she speaks to him, the system would make her voice sound louder than the television audio, which is lowered in volume and will sound quieter, so she can communicate with him even though grandpa is hearing impaired and using a wearable device to augment the television sound or other sound.

In addition, some implementations can automatically transition between noise canceling and noise reduction with selective audio transparency that elevates and identifies specific inputs. So, a user can keep their headphones and noise reducing aspects turned on and still be in touch with the outside world or specific sounds.

In some implementations, the system can include an artificial intelligence/machine learning (AI/ML) aspect trained to detect when external noises exceeded safety limits and switch automatically from noise canceling (e.g., where headphones are actively canceling exterior sound or noise) to transparency mode (e.g., where selected sounds are permitted to pass through or be amplified), or vice versa. For example, when a person is walking down the street and traffic sound occurs and reaches a given threshold, the system can automatically switch to transparency mode using the AI/ML model to detect when, for safety reasons, it is better if the person does not have noise canceling and the system brings in outside sounds (e.g., traffic sounds).

In general, some implementations can elevate some voices over others or some voices over ambient noise during a telephone call, whether the user is using headphones or not.

In some implementations, instead of a sound, the system can give the user an alert so the user can choose what they want. For example, the user is walking, and they have their noise canceling on and footsteps are coming up behind. Instead of allowing the sound of footsteps coming through, the system should be able to also provide the user with an audible notification (e.g., a bell or ding sound followed by an audible message such as “footsteps behind you”). In another example, a user may be sitting on a plane and the system gives the user a ding if a pilot or crew member announcement comes on the PA for the aircraft. So instead of just allowing noise through or blocking all external sound, the system can be configured to provide a notification that there's noise and what that noise is, which can be configured in the application.

The systems and methods provided herein may overcome one or more deficiencies of some conventional noise cancellation or audio processing systems and methods. For example, some implementations can identify a selected sound and essentially enhance that sound while attenuating or canceling other sounds such as background noise. Further, some implementations can provide enhanced sound awareness by operating in conjunction with earphones and/or mobile devices to place audio into the sound path being heard by a listener and to make the selected audio enhanced by amplifying the selected audio and/or attenuating the audio signal the user was listening to. In addition to the above, the system can act as a noise canceling system by attenuating all sounds but sounds that are determined to be selected and permitted to come through the audio system to the listener or user.

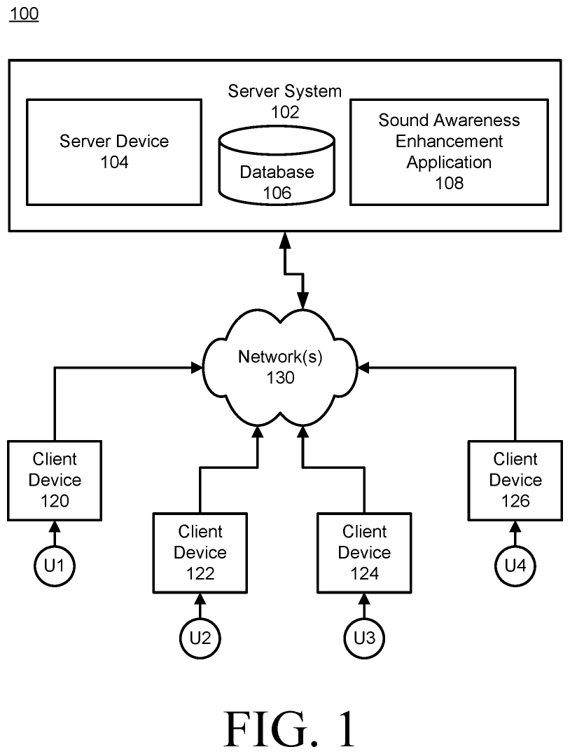

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and a sound awareness enhancement application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client (or user) device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide sound awareness enhancement functions.

Various implementations of features described herein can use any type of system and/or service. Any type of electronic device can make use of features described herein. Some implementations can provide one or more features described herein on client or server devices disconnected from or intermittently connected to computer networks.

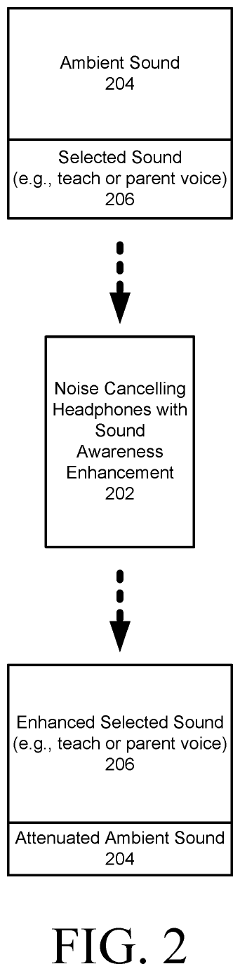

FIG. 2 is a diagram of an example sound awareness enhancement system 202 including noise canceling headphones in accordance with some implementations. The headphones can include augmented reality type headphones that can be worn by a user as standalone device or as part of an augmented reality or extended reality system. The user can include, for example, a child or other person with sensory issues and the headphones can reduce or block out external noises (204) but allow certain noises or sounds (206) to come through in order to help the user study or perform other tasks. For example, a child with significant sensory issues may be in a school or other place that has significant noise which may trigger the child to have an adverse response to the noise. The potential for the adverse reaction can be reduced or eliminated by an implementation that can either include a special type of headphone or new technology or having an app running on a mobile device that makes their existing headphones perform the sound awareness enhancement functions described herein, e.g., to reduce or block out some or all external noises except for the sounds that they specifically want to hear (i.e., that have been selected or used to train the system) such as the sound of the voice of a teacher or a parent, friend or caregiver. This can help the child or other user with sensory issues to focus and minimize external stimulus reduce or eliminate adverse reactions due to noise or sound stimulation. In general, some implementations can include a wearable tech type that can either enhance or decrease and control external stimulus according to the configuration.

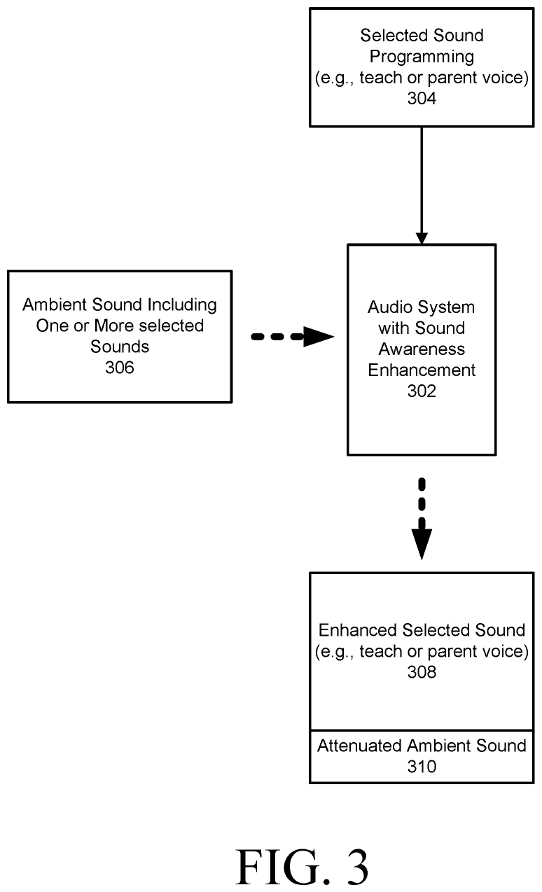

FIG. 3 is a diagram of an example sound awareness enhancement system including an audio system in accordance with some implementations. For example, a user can download favorites 304 into the application 302 and it is configured to enhance the voices 308 and minimize the others 306/310. For example, a user and spouse are in a concert, crowded room, or place that's just plain noisy, the system can magnify the spouse's voice in the user's ear and minimize the external noise. So, the system can be programmable and controllable as to which sounds are selected for enhancement and which sounds are reduced or attenuated in volume.

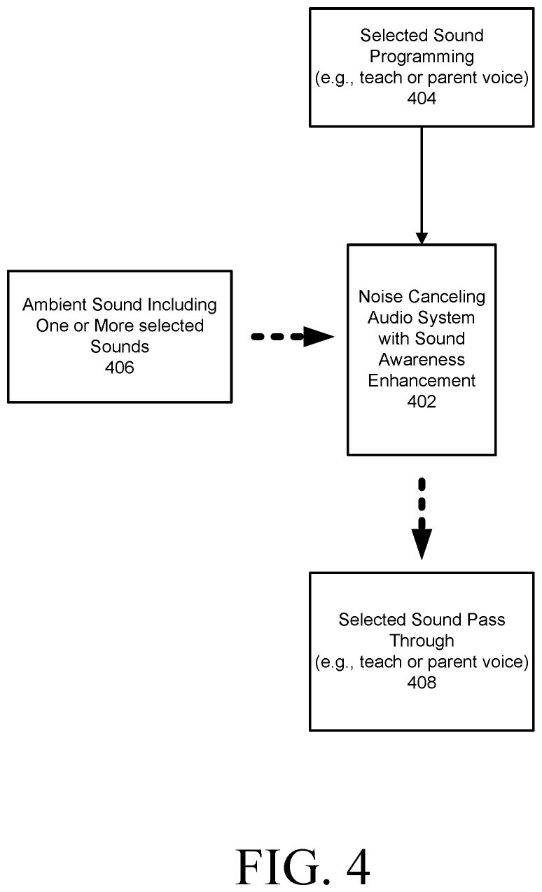

FIG. 4 is a diagram of an example sound awareness enhancement system including a noise canceling audio system 402 in accordance with some implementations. In some implementations, the system can cancel noise 406 for hearing protection but allowing specific noises or sounds 404 through or specifically allowing certain noises or sounds 408 through by amplifying it above all other ambient noises or decrease all down to a certain decibel.

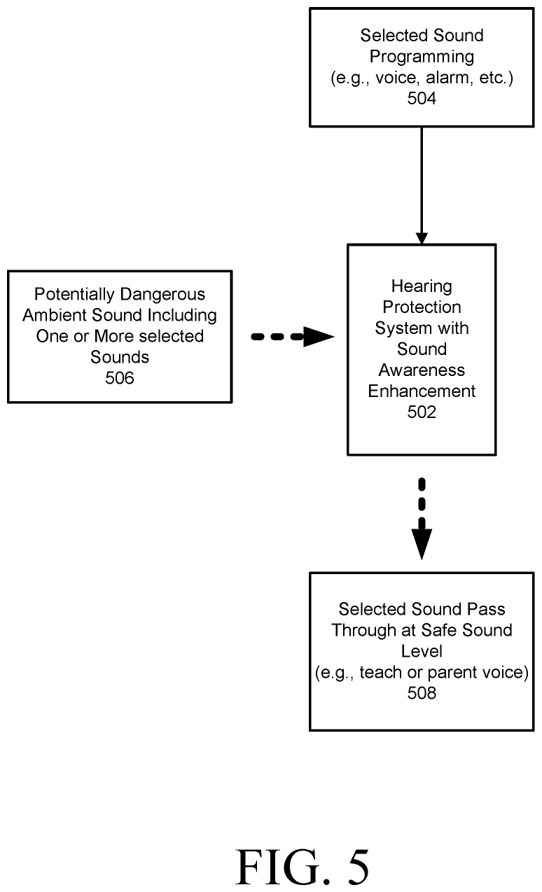

FIG. 5 is a diagram of an example sound awareness enhancement system including a hearing protection system 502 in accordance with some implementations. For example, for an individual who works in an industry such as construction, mechanics, at an airport, at a concert, at a gun range, or a loud environment (e.g., where sounds can be above a predetermined decibel threshold) where they need to wear hearing protection but still need to hear specific noises, the system 502 can be programmed or trained with selected sounds 504 and then protect the user's hearing by canceling potentially dangerous ambient sounds 506 and permitting the selected sounds to pass through at a safe sound level 508.

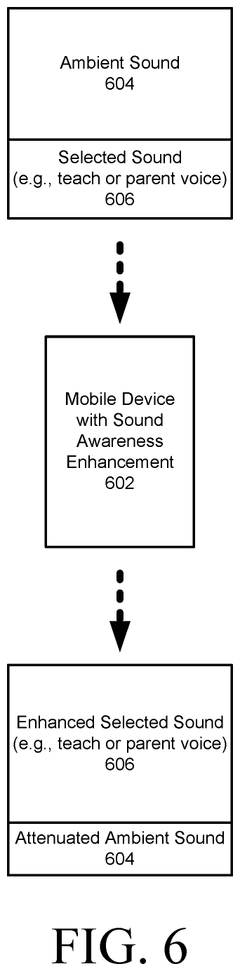

FIG. 6 is a diagram of an example sound awareness enhancement system including a mobile device 602 in accordance with some implementations. In this implementation, the system is integrated into the mobile device and performs the sound awareness enhancement functions as an application running on the mobile device to take in ambient sound 604 and selected sounds 606 (e.g., the user's voice on a phone call) and to enhance the selected sound 606 and reduce the ambient sound 604.

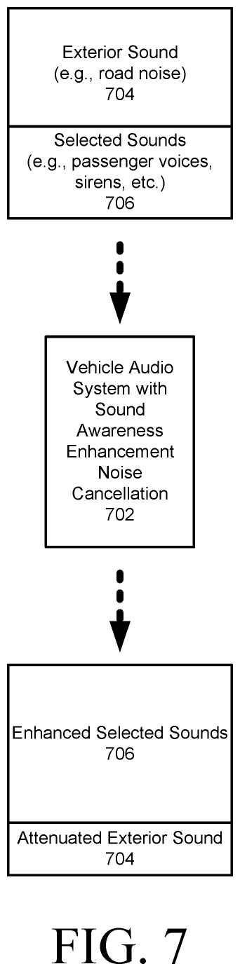

FIG. 7 is a diagram of an example sound awareness enhancement system including a vehicle audio system 702. For example, the system can operate inside of a car or other vehicle and reduce or cancel noise from outside 704 and permit selected sounds 706 to come through (e.g., voices, siren, warnings, etc.). In some implementations, the system 702 can utilize the audio components of the vehicle such as microphones and speakers.

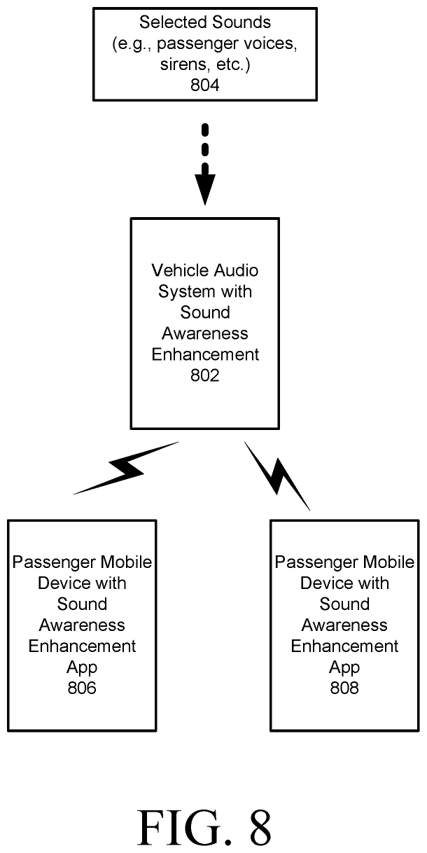

FIG. 8 is a diagram of an example sound awareness enhancement system including a vehicle audio system 802 in communication with mobile devices (806 and 808) in accordance with some implementations. In particular, the vehicle audio system 802 can be programmed or trained with selected sounds 804 and then can cancel background noise or exterior noise but permit the selected sounds 804 to be transmitted to passenger mobile devices 806 and 808, where the selected sounds can be merged into the audio of the mobile device and enhanced to be heard over other audio the mobile devices may be playing at the moment. The selected audio can also be sent through the speakers of the vehicle. Some implementations can utilize Bluetooth or other similar technology or be able to switch between Bluetooth and whatever the new Bluetooth is.

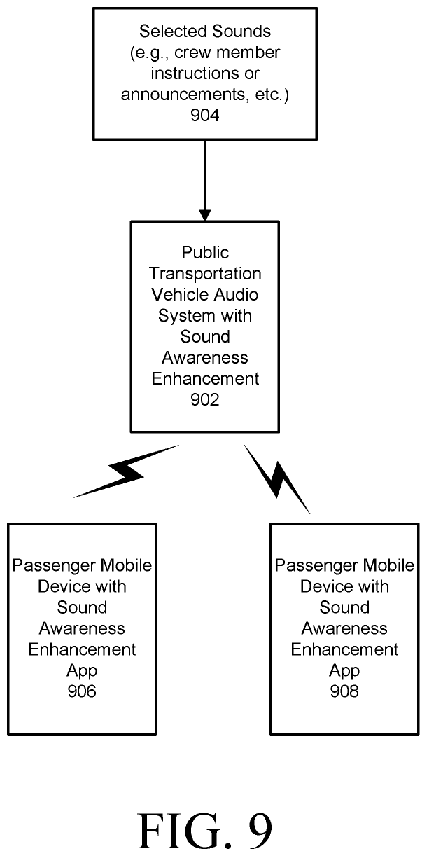

FIG. 9 is a diagram of an example sound awareness enhancement system including a public transportation vehicle audio system 902 in accordance with some implementations. For example, in a public transportation vehicle such as an airliner, a user can be using the noise reduction system through the headphones, but when the aircraft PA system comes on (i.e., a selected sound 904) and the pilot begins to give directions or instructions, the system 902 sends the selected sound 904 audio to passenger mobile devices (if configured or programmed by the user for this task) and the application on the user mobile devices magnifies the pilot's voice in their ears while continuing to play their movie or other audio. Alternatively, the system can pause the movie or other audio and magnify the pilot's voice. The user can configure how the mobile application works in conjunction with the system 902.

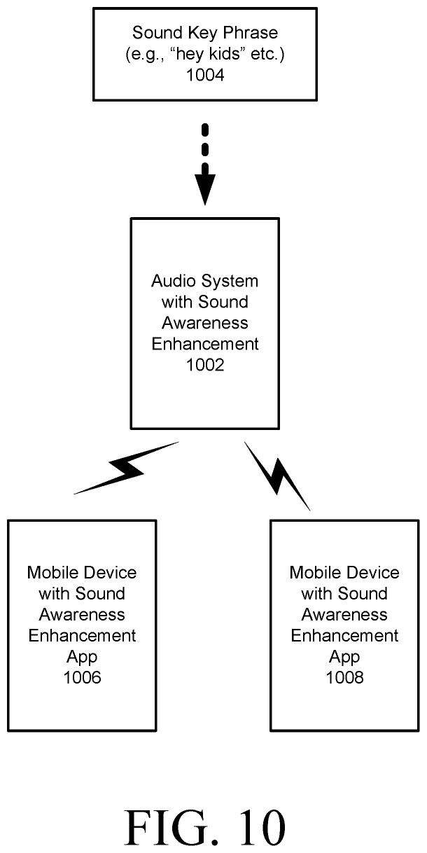

FIG. 10 is a diagram of an example sound awareness enhancement system including an audio system 1002 in communication with one or more mobile devices in accordance with some implementations. In an example scenario, a parent may be trying to get a kid's attention while they are on their iPad, playing on a game console or portable game device, or using a mobile with headphones. The mobile devices (1006 and 1008) can including any user or client device described herein and can be running an implementation of the sound awareness enhancement system and/or may get a signal from a central system 1002. In some implementations, the kid's mobile device and headphones can recognize the father's external voice and permit it to come through the kids' headphones and possibly be enhanced. In another example, the audio system 1002 detects the father's voice (a selected sound) and sends the father's voice audio signal to the mobile devices for playing through the headphones or earbuds. In yet another example, the parent has an app with a user interface element such as a button that, when pressed, causes an override in the mobile devices 1006 and 1008 to permit the parent's audio to be heard by the mobile device users through their headphones or earbuds.

Further, the signal to send the parent audio to the mobile devices can include the parent or other user saying a key phrase 1004 (e.g., “hey kids”). This can act as the signal for the system to send the parent audio to the mobile devices 1006 and 1008 or to cause the mobile device to lower other sounds such as a movie or music and permit the parent voice to be enhanced and heard.

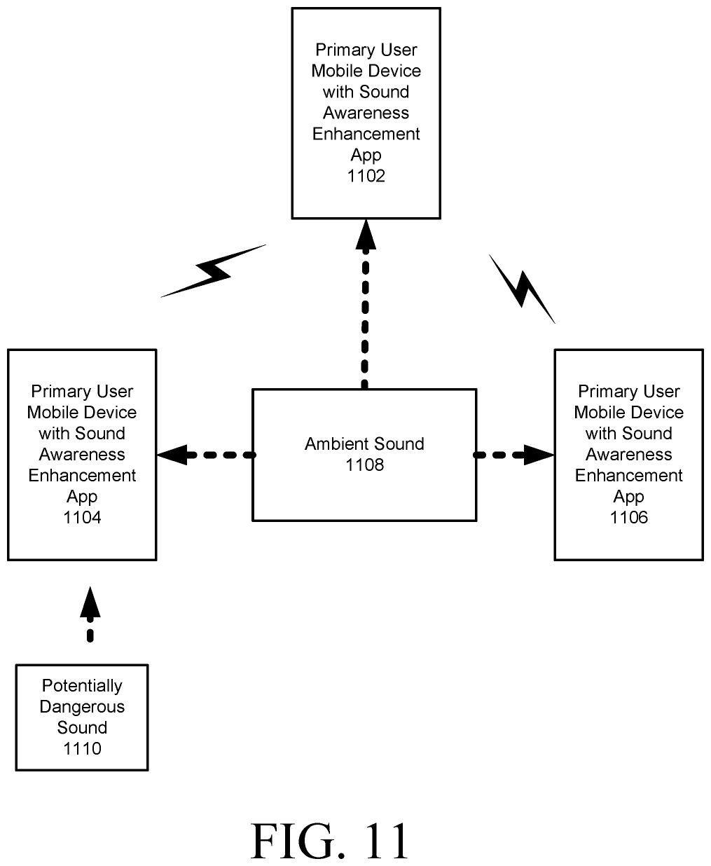

FIG. 11 is a diagram of an example sound awareness enhancement system including mobile communication devices with a primary device 1102 and one or more secondary devices 1104/1106 in accordance with some implementations. For example, in a military use scenario, a commander may be using 1102 with subordinate team members using 1104 and 1106, respectively. When the commander speaks, device 1102 detects this as a selected sound and cause the other sounds on the communications channel to be lowered and the commanders voice to be enhanced so that the user of 1104 and 1006 can hear the commander. The systems can reduce or cancel the ambient sound 1108.

Some implementations can be preprogramed to muffle sounds above a certain decibel. This way the individual could still hear their commander providing orders even if they are shooting guns, etc. Further, some implementations can register any noise that comes in over a certain decibel level, For example, the system can be constantly monitoring and detecting sound for audio health records. Returning to the military application example, occurrence of a noise over a certain decibel level 1110 could be recorded and the system could try to determine a location of the sounds (especially if two or more users are present using triangulation or other technique) to create a forensic record of the noise and its approximate location relative to the users and possibly even the distance from the users.

FIG. 12 is a block diagram of an example device 1200 which may be used to implement one or more features described herein. In one example, device 1200 may be used to implement a client device, e.g., any of client devices 120-126 shown in FIG. 1. Alternatively, device 1200 can implement a server device, e.g., server device 104, etc. In some implementations, device 1200 may be used to implement a client device, a server device, or a combination of the above. Device 1200 can be any suitable computer system, server, or other electronic or hardware device as described above.

One or more methods described herein (e.g., as shown in FIGS. 2-11) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 1200 includes a processor 1202, a memory 1204, and I/O interface 1206. Processor 1202 can be one or more processors and/or processing circuits to execute program code and control basic operations of the device 1200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 1202 may include one or more co-processors that implement neural-network processing. In some implementations, processor 1202 may be a processor that processes data to produce probabilistic output, e.g., the output produced by processor 1202 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1204 is typically provided in device 1200 for access by the processor 1202 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 1202 and/or integrated therewith. Memory 1204 can store software operating on the server device 1200 by the processor 1202, including an operating system 408, machine-learning application 1230, sound awareness enhancement application 1210, and application data 1212. Other applications may include applications such as a data display engine, web hosting engine, image display engine, notification engine, social networking engine, etc. In some implementations, the machine-learning application 1230 and sound awareness enhancement application 1210 can each include instructions that enable processor 1202 to perform functions described herein, e.g., some or all of the methods of FIGS. 2-11.

The machine-learning application 1230 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a sound awareness enhancement application 1210 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 1230 may utilize Bayesian classifiers, support vector machines, neural networks, or other learning techniques. In some implementations, machine-learning application 1230 may include a trained model 1234, an inference engine 1236, and data 1232. In some implementations, data 432 may include training data, e.g., data used to generate trained model 1234. For example, training data may include any type of data suitable for training a model for sound awareness enhancement tasks, such as audio data, labels, thresholds, etc. associated with sound awareness enhancement described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 1234, training data may include such user data. In implementations where users permit use of their respective user data, data 1232 may include permitted data.

In some implementations, data 1232 may include collected data such as audio data or signals. In some implementations, training data may include synthetic data generated for the purpose of training, such as data that is not based on user input or activity in the context that is being trained, e.g., data generated from simulated conversations, computer-generated images, etc. In some implementations, machine-learning application 1230 excludes data 1232. For example, in these implementations, the trained model 1234 may be generated, e.g., on a different device, and be provided as part of machine-learning application 1230. In various implementations, the trained model 1234 may be provided as a data file that includes a model structure or form, and associated weights. Inference engine 1236 may read the data file for trained model 1234 and implement a neural network with node connectivity, layers, and weights based on the model structure or form specified in trained model 1234.

Machine-learning application 1230 also includes a trained model 1234. In some implementations, the trained model 1234 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 1232 or application data 1212. Such data can include, for example, images, e.g., when the trained model is used for sound awareness enhancement functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image is functional, etc. depending on the specific trained model. In some implementations, model form or structure also specifies a number and/or type of nodes in each layer.

In different implementations, the trained model 1234 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 1234 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 1232, to produce a result.

For example, training may include applying supervised learning techniques. In supervised learning, the training data can include a plurality of inputs (e.g., a set of images) and a corresponding expected output for each input (e.g., one or more labels for each image representing aspects of a project corresponding to the images such as services or products needed or recommended). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify sound awareness enhancement labels that are associated with audio data and/or select thresholds for sound awareness enhancement tasks.

In another example, a model trained using unsupervised learning may cluster words based on the use of the words in data sources. In some implementations, unsupervised learning may be used to produce knowledge representations, e.g., that may be used by machine-learning application 1230. In various implementations, a trained model includes a set of weights, or embeddings, corresponding to the model structure. In implementations where data 1232 is omitted, machine-learning application 1230 may include trained model 1234 that is based on prior training, e.g., by a developer of the machine-learning application 1230, by a third-party, etc. In some implementations, trained model 1234 may include a set of weights that are fixed, e.g., downloaded from a server that provides the weights.

Machine-learning application 1230 also includes an inference engine 1236. Inference engine 1236 is configured to apply the trained model 1234 to data, such as application data 1212, to provide an inference. In some implementations, inference engine 1236 may include software code to be executed by processor 1202. In some implementations, inference engine 1236 may specify circuit configuration (e.g., for a programmable processor, for a field programmable gate array (FPGA), etc.) enabling processor 1202 to apply the trained model. In some implementations, inference engine 1236 may include software instructions, hardware instructions, or a combination. In some implementations, inference engine 1236 may offer an application programming interface (API) that can be used by operating system 1208 and/or sound awareness enhancement application 1210 to invoke inference engine 1236, e.g., to apply trained model 1234 to application data 1212 to generate an inference.

Machine-learning application 1230 may provide several technical advantages. For example, when trained model 1234 is generated based on unsupervised learning, trained model 1234 can be applied by inference engine 1236 to produce knowledge representations (e.g., numeric representations) from input data, e.g., application data 1212. For example, a model trained for sound awareness enhancement tasks may produce predictions and confidences for given input information about sound awareness enhancement. A model trained for suggesting sound awareness enhancement tasks may produce a prediction based on input audio or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 1236.

In some implementations, knowledge representations generated by machine-learning application 1230 may be provided to a different device that conducts further processing, e.g., over a network. In such implementations, providing the knowledge representations rather than the images may provide a technical benefit, e.g., enable faster data transmission with reduced cost. In another example, a model trained for sound awareness enhancement tasks may produce a sound awareness enhancement signal for one or more audio signals being processed by the model.

In some implementations, machine-learning application 1230 may be implemented in an offline manner. In these implementations, trained model 1234 may be generated in a first stage and provided as part of machine-learning application 1230. In some implementations, machine-learning application 1230 may be implemented in an online manner. For example, in such implementations, an application that invokes machine-learning application 1230 (e.g., operating system 1208, one or more of sound awareness enhancement application 1210 or other applications) may utilize an inference produced by machine-learning application 1230, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 1234, e.g., to update embeddings for trained model 1234.

In some implementations, machine-learning application 1230 may be implemented in a manner that can adapt to particular configuration of device 1200 on which the machine-learning application 1230 is executed. For example, machine-learning application 430 may determine a computational graph that utilizes available computational resources, e.g., processor 1202. For example, if machine-learning application 1230 is implemented as a distributed application on multiple devices, machine-learning application 1230 may determine computations to be carried out on individual devices in a manner that optimizes computation. In another example, machine-learning application 1230 may determine that processor 1202 includes a GPU with a particular number of GPU cores (e.g., 1000) and implement the inference engine accordingly (e.g., as 1000 individual processes or threads).

In some implementations, machine-learning application 1230 may implement an ensemble of trained models. For example, trained model 1234 may include a plurality of trained models that are each applicable to same input data. In these implementations, machine-learning application 1230 may choose a particular trained model, e.g., based on available computational resources, success rate with prior inferences, etc. In some implementations, machine-learning application 1230 may execute inference engine 1236 such that a plurality of trained models is applied. In these implementations, machine-learning application 1230 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 1208 or one or more other applications, e.g., sound awareness enhancement application 1210.

In different implementations, machine-learning application 1230 can produce different types of outputs. For example, machine-learning application 1230 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 1230 may produce an output video with a particular effect applied, e.g., rendered in a comic-book or particular artist's style, when trained model 1234 is trained using training data from the comic book or particular artist, etc. In some implementations, machine-learning application 1230 may produce an output based on a format specified by an invoking application, e.g., operating system 1208 or one or more applications, e.g., sound awareness enhancement application 1210. In some implementations, an invoking application may be another machine-learning application. For example, such configurations may be used in generative adversarial networks, where an invoking machine-learning application is trained using output from machine-learning application 1230 and vice-versa.

Any of software in memory 1204 can alternatively be stored on any other suitable storage location or computer-readable medium. In addition, memory 1204 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 1204 and any other type of storage (magnetic disk, optical disk, magnetic tape, or other tangible media) can be considered “storage” or “storage devices.”

I/O interface 1206 can provide functions to enable interfacing the server device 1200 with other systems and devices. Interfaced devices can be included as part of the device 400 or can be separate and communicate with the device 1200. For example, network communication devices, storage devices (e.g., memory and/or database 106), and input/output devices can communicate via I/O interface 1206. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 1206 can include one or more display devices 1220 and one or more data stores 1238 (as discussed above). The display devices 1220 that can be used to display content, e.g., a user interface of an output application as described herein. Display device 1220 can be connected to device 400 via local connections (e.g., display bus) and/or via networked connections and can be any suitable display device. Display device 1220 can include any suitable display device such as an LCD, LED, or plasma display screen, CRT, television, monitor, touchscreen, 3-D display screen, or other visual display device. For example, display device 1220 can be a flat display screen provided on a mobile device, multiple display screens provided in a goggles or headset device, or a monitor screen for a computer device.

The I/O interface 1206 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 12 shows one block for each of processor 1202, memory 1204, I/O interface 1206, and software blocks 1208, 1210, and 1230. These blocks may represent one or more processors or processing circuitries, operating systems, memories, I/O interfaces, applications, and/or software modules. In other implementations, device 1200 may not have all of the components shown and/or may have other elements including other types of elements instead of, or in addition to, those shown herein. While some components are described as performing blocks and operations as described in some implementations herein, any suitable component or combination of components of environment 100, device 1200, similar systems, or any suitable processor or processors associated with such a system, may perform the blocks and operations described.

In some implementations, logistic regression can be used for personalization (e.g., personalizing sound awareness enhancement predictions based on previous sound awareness enhancement data). In some implementations, the prediction model can be handcrafted including hand selected sound awareness enhancement labels and thresholds. The mapping (or calibration) from ICA space to a predicted precision within the sound awareness enhancement space can be performed using a piecewise linear model.

In some implementations, the sound awareness enhancement system could include a machine-learning model (as described herein) for tuning the system (e.g., selecting sound awareness enhancement labels and corresponding thresholds) to potentially provide improved accuracy. Inputs to the machine learning model can include ICA labels, an image descriptor vector that describes appearance and includes semantic information about sound awareness enhancement data. Example machine-learning model input can include labels for a simple implementation and can be augmented with descriptor vector features for a more advanced implementation. Output of the machine-learning module can include a prediction of which sounds are selected sounds to be enhanced and which are other sounds to be attenuated or removed.

One or more methods described herein (e.g., as shown in FIGS. 2-11) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
activating a sound awareness enhancement application on a first device and a second device;
configuring the sound awareness enhancement application activated on the first device to recognize a selected sound;
causing a graphical user interface to be displayed on a display of the first device, where the graphical user interface includes a transmit element;
transmitting sound from the first device to the second device when a condition is met, wherein the condition includes detecting at the first device through a sound sensor of the first device that the selected sound has been detected, or detecting that the transmit element has been selected in the graphical user interface;
receiving sound at the second device transmitted from the first device; and
providing the sound through the sound awareness enhancement application of the second device.

2. The computer-implemented method of claim 1, wherein the first device is a mobile phone.

3. The computer-implemented method of claim 1, wherein the second device is a mobile phone.

4. The computer-implemented method of claim 1, wherein the sound awareness enhancement application on the first device is configured to filter sounds other than the selected sound.

5. The computer-implemented method of claim 1, wherein the selected sound includes a phrase spoken by a user of the first device.

6. The computer-implemented method of claim 1, wherein sound is captured at the first device for a duration of time that the transmit element is selected.

7. The computer-implemented method of claim 1, wherein providing the sound through the sound awareness enhancement application of the second device includes lowering a volume of audio playing on the second device and providing the sound from the first device at a volume level above the lowered volume of the audio playing on the second device.

8. A computer-implemented method comprising:
activating a sound awareness enhancement application on a device, wherein the sound awareness enhancement application includes a first mode that is a noise canceling mode and a second mode that is an audio transparency mode;
setting a threshold sound volume level in the sound awareness enhancement application;
detecting, at the sound awareness enhancement application, a volume level of the ambient sound around the device;
periodically comparing the volume level of the ambient sound to the threshold sound volume level;
operating the sound awareness enhancement application in the noise cancelling mode;
when a detected sound volume at the device exceeds the threshold sound volume level, switching to the audio transparency mode in which sound exterior to the device is captured and provided to a user of the device; and
when the detected sound volume at the device falls below the threshold sound volume level, dynamically switching to the noise cancelling mode.

9. The computer-implemented method of claim 8, wherein the threshold sound volume level is manually adjustable.

10. The computer-implemented method of claim 8, wherein the threshold sound volume level adjusts automatically and dynamically in response to ambient sound levels.

11. The computer-implemented method of claim 8, wherein audio transparency mode includes passing only selected sounds through to a user.

12. A computer-implemented method comprising:
activating a sound awareness enhancement application on a primary device and a plurality of secondary devices;
configuring the sound awareness enhancement application activated on the primary device to recognize a selected sound;
transmitting sound from the primary device to the secondary devices when a condition is met, wherein the condition includes detecting at the primary device through a sound sensor of the primary device that the selected sound has been detected;
receiving sound at the secondary devices transmitted from the primary device; and
providing the sound through the sound awareness enhancement application of the secondary devices.

13. The computer-implemented method of claim 12, wherein the primary device is one of a mobile phone or a radio.

14. The computer-implemented method of claim 12, wherein the secondary devices are mobile phones or radios.

15. The computer-implemented method of claim 12, wherein the sound awareness enhancement application on the primary device is configured to filter sounds other than the selected sound.

16. The computer-implemented method of claim 12, wherein the selected sound includes a voice sound of a user of the primary device.

17. The computer-implemented method of claim 12, wherein providing the sound through the sound awareness enhancement application of the secondary devices includes lowering a volume of audio playing on the secondary devices and providing the sound from the primary device at a volume level above the lowered volume of the audio playing on the secondary devices.
